(19) United States
(12) Patent Application Publication
(10) Pub. No.: US 2020/0286106 A1
(43) Pub. Date: Sep. 10, 2020

(54) OPTIMIZATION OF ON-DEMAND TRANSPORTATION SYSTEMS

(71) Applicant: Lyft, Inc., San Francisco, CA (US)

(72) Inventors: Guillaume Arnaud Candeli, San Francisco, CA (US); Tzu-Hsin Chiao, Seattle, WA (US); Adriel Frederick, Berkeley, CA (US); Varun Ramakrishna Pattabhiraman, San Francisco, CA (US); Shaswat Pratap Shah, San Francisco, CA (US); Ashivni Shekhawat, Emeryville, CA (US); Yanqiao Wang, San Francisco, CA (US); Irena Stephanie Vezich, San Francisco, CA (US); Vijay Tupil Narasiman, San Francisco, CA (US); Keshave Puranmalka, Seattle, WA (US)

(21) Appl. No.: 16/291,964

(22) Filed: Mar. 4, 2019

(51) Int. Cl. G06Q 30/02; G06Q 10/02; G06Q 10/04; G06Q 50/30

(52) U.S. Cl. CPC G06Q 30/0202; G06Q 50/30; G06Q 10/04; G06Q 10/02

(57) ABSTRACT

This disclosure describes a transportation matching system that utilizes a combination of an offline transportation optimization model and an online transportation optimization model to generate transportation metric functions for predicted and received transportation requests based on optimization parameters. The disclosed systems utilize an offline transportation optimization model to predict transportation requests and to generate corresponding transportation metric functions for given locations over particular time intervals. The disclosed systems further utilize an online transportation optimization model to receive transportation requests and generate transportation metric functions for the received requests based at least in part on the predicted transportation requests and corresponding metric functions.

### BACKGROUND

In recent years, both popularity and usage of on-demand transportation matching systems have increased. Indeed, the proliferation of web and mobile applications enable requesting individuals to request transportation from one geographic location to another. For instance, an on-demand transportation matching system can receive transportation requests and pair the requests with providers that can transport requesting individuals to destination locations. In addition, the on-demand transportation matching system can provide tools to providers to help pick up requesting individuals as well as to help transport them to the destination locations.

Despite the advances of these systems, conventional on-demand transportation matching systems continue to suffer from a number of disadvantages, particularly in their accuracy and flexibility. As an initial problem, conventional on-demand transportation matching systems are inaccurate because they can generally only produce target metrics for large-scale data. To illustrate, conventional systems analyze request information for a given geographic region and predict future performance of the same region based on historical data. However, because these conventional systems analyze such information over geographic regions (which in some cases may be large or may even be system-wide), these systems lack the necessary granularity to generate metrics on a more precise level.

In addition, conventional on-demand transportation matching systems are inflexible. Particularly, conventional systems are limited to targeting goals based on prior data. To illustrate, a conventional system can observe a number of transportation requests for a given geographic region and can generate a metric for the geographic region based on the prior observed requests. However, because these conventional systems depend on prior data for a given region, these systems cannot flexibly adapt to new request information to generate meaningful predictions under circumstances that are less constant or repetitive.

These along with additional problems and issues exist with conventional on-demand transportation matching systems.

### SUMMARY

This disclosure describes one or more embodiments of methods, non-transitory computer-readable media, and systems that solve the foregoing problems in addition to providing other benefits. While this summary refers to systems for simplicity, the summary also applies to certain disclosed methods and non-transitory computer-readable media. To solve the foregoing and other problems, the disclosed systems generate a transportation metric function for received transportation request information by determining optimization parameters corresponding to target effects associated with the transportation request information. Particularly, the disclosed systems utilize a combination of an offline transportation optimization model and an online transportation optimization model to generate a transportation metric function based on various received and/or predicted transportation request information.

To generate the transportation metric using an online transportation optimization model, the disclosed systems further utilize an offline transportation optimization model to predict transportation requests and to generate corresponding transportation metric functions as a basis for generating or determining the transportation metric function for the received request. Thus, the disclosed systems generate a transportation metric by utilizing an online transportation optimization model based on the predictions and generated functions of the offline transportation optimization model. Because of the accuracy and flexibility achieved by the disclosed systems, the disclosed systems can adapt to current received requests on the fly to provide transportation metrics targeted to each specific transportation request. In addition, depending on the optimization parameters, the disclosed systems can adjust transportation metric functions and corresponding transportation metrics to generate specific, targeted effects corresponding to one or more transportation requests.

The following description sets forth additional features and advantages of one or more embodiments of the disclosed methods, non-transitory computer-readable media, and systems. In some cases, such features and advantages are evident to a skilled artisan from the description or learned by the practice of the disclosed embodiments.

### BRIEF DESCRIPTION OF THE DRAWINGS

The detailed description refers to the drawings briefly described below.

FIG. 1 illustrates a block diagram of an environment for implementing a dynamic transportation matching system in accordance with one or more embodiments.

FIG. 2 illustrates an architecture of the transportation matching system including an offline transportation optimization model and an online transportation optimization model in accordance with one or more embodiments.

FIG. 3 illustrates an example geographic region in which the transportation matching system can operate to generate transportation metrics in accordance with one or more embodiments.

FIG. 4 illustrates an example process to train an elasticity model in accordance with one or more embodiments.

FIG. 5 illustrates an example architecture of an elasticity model in accordance with one or more embodiments.

FIG. 6 illustrates a flowchart of a series of acts for generating and providing transportation metrics in accordance with one or more embodiments.

FIG. 7 illustrates a block diagram of a computing device for implementing one or more embodiments of the present disclosure.

FIG. 8 illustrates an example environment for a dynamic transportation matching system in accordance with one or more embodiments.

### DETAILED DESCRIPTION

This disclosure describes a dynamic transportation matching system that utilizes one or more models to generate a transportation metric function for received transportation request information by determining optimization parameters corresponding to target effects. In some embodiments, the transportation matching system utilizes a combination of an online transportation optimization model and an offline transportation optimization model to generate transportation metrics for transportation request information (of transportation requests) based on predicting transportation requests. The transportation matching system can generate transportation metrics with aims to accomplish a variety of goals such as transportation request volume, transportation provider surplus, long-term growth of providers and/or requesters, among others. The transportation matching system can even consider other factors such as transportation provider expectations, requester expectations, and total economic value. As an example, the transportation matching system can generate a transportation metric based on predicted transportation requests for a given location aimed at the target effect of increasing a total number of transportation requests at the location. In addition to utilizing predicted transportation requests, the transportation matching system can optimize a transportation metric for a given target effect based on optimization parameters.

To elaborate on generating or determining a transportation metric, the transportation matching system can receive a transportation request from a requester device. In particular, the transportation request can include various transportation request information such as a request origin, a request time, a request destination, and/or a request mode (e.g., type of transportation). The transportation matching system can determine a transportation metric function specific to the transportation request information of the transportation request.

More specifically, the transportation matching system can identify a transportation metric function from among a number of transportation metric functions generated for predicted and/or actual transportation requests based on the specific characteristics (e.g., locations, time, etc.) of the transportation requests. Indeed, the transportation matching system can utilize an offline transportation optimization model to generate predicted transportation requests based on historical data. In some embodiments, the transportation matching system can identify a previously-generated transportation metric function for a predicted transportation request that corresponds to the received transportation request. Additionally or alternatively, the transportation matching system can generate a transportation metric function if no previously-generated transportation metric function corresponds to data matching the received transportation request.

Indeed, the transportation matching system can utilize the offline transportation optimization model to generate transportation metric functions for the predicted transportation requests. Thus, the transportation matching system can pre-generate transportation metric functions for transportation requests expected to be received within a particular geographic area over a given time interval. Based on the transportation metric functions of the predicted transportation requests, the transportation matching system can further determine a transportation metric function corresponding to the received transportation request. For instance, the transportation matching system can utilize an online transportation optimization model to identify a previously-generated transportation metric function for a predicted transportation request that corresponds to a received transportation request.

In some embodiments, the transportation matching system can train and utilize an elasticity model to generate a transportation metric function for a received transportation request. For instance, the transportation matching system can train and utilize an elasticity model in the form of a machine learning model (e.g., a neural network) to generate a transportation metric function for received transportation requests based observed transportation metrics for past transportation requests.

In addition, the transportation matching system can determine one or more optimization parameters. To elaborate, the transportation matching system can determine one or more parameters to optimize to achieve a particular target effect. Indeed, the transportation matching system can receive an indication of one or more goals or target effects associated with a transportation request. Thus, to achieve the target effects, the transportation matching system can utilize one or more optimization parameters as a basis for generating or determining a transportation metric. To illustrate by way of an example, the transportation matching system can determine an optimization parameter such as an indication to optimize the system for increasing the total transportation request volume in a given geographic region. Based on the optimization parameter, the transportation matching system can utilize the offline transportation optimization model and the online transportation optimization model to generate a transportation metric (e.g., a price). In some embodiments, the transportation matching system can receive optimization parameters from user input (e.g., from an administrator device), while in other embodiments the transportation matching system can determine the optimization parameters automatically without user input.

The transportation matching system can generate a transportation metric utilizing a transportation metric function. To illustrate, the transportation matching system can generate transportation metrics for predicted transportation requests by utilizing the offline transportation optimization model. As mentioned above, the transportation matching system can also generate a transportation metric function for a received transportation request by utilizing an online transportation optimization model. Using the generated transportation metric function pertaining to a particular transportation request, the transportation matching system generates a transportation metric for the particular transportation metric.

As mentioned, the transportation matching system can generate a transportation metric that is optimized according to one or more optimization parameters. Indeed, based on receiving one or more optimization parameters, the transportation matching system can implement a particular optimization algorithm to generate transportation metrics that produce targeted effects. For example, the transportation matching system can implement an optimization algorithm based on a number of transportation requests served between a particular origin and destination. Additional detail regarding the optimization algorithm is provided below with reference to the figures.

In some embodiments, the transportation matching system generates a transportation metric further based on request features associated with a respective transportation request. To illustrate, the transportation matching system can utilize an online transportation optimization model and/or an offline transportation optimization model to generate request features for predicted transportation requests. In addition, the transportation matching system can utilize a feature generator model to store generated request features (e.g., a shadow price or an incentive cost) associated with the origin, destination, time, and/or mode of individual transportation requests. Thus, based on the request features and the transportation metric functions of the predicted transportation requests, the transportation matching system can generate, store, and track transportation metrics for predicted transportation requests (e.g., via an offline transportation optimization model). In addition, based on a combination of the predicted transportation requests as well as generated transportation metric functions of received transportation requests, the transportation matching system can generate, store, and track transportation metrics for received transportation requests (e.g., via an online transportation optimization model).

As outlined, the transportation matching system provides several advantages and benefits over conventional on-demand transportation matching systems. For instance, unlike conventional systems that only analyze transportation requests over large geographic regions, the transportation matching system analyzes more granular information. More particularly, the transportation matching system analyzes information on a route-by-route basis to generate more tailored, more accurate transportation metrics on a detailed route level rather than on a general region level.

In addition, the transportation matching system generates transportation metrics for new transportation requests on the fly in real time (or near real time). Indeed, rather than relying solely on past information to predict metrics for transportation requests, the transportation matching system receives transportation request information with a new (e.g., a current, “live,” dynamic, contemporaneous, or real-time) transportation request and utilizes a trained elasticity model to generate transportation metrics for the new transportation request. Thus, by utilizing transportation information of new transportation requests, the transportation matching system is more accurate than conventional on-demand matching systems.

Furthermore, the transportation matching system is more flexible than conventional systems. In particular, unlike conventional systems that are more rigid in their application, the transportation matching system can adapt to different optimization parameters to produce transportation metrics for different target effects. Indeed, whereas a conventional system is generally built from the ground up for a single predetermined purpose (e.g., to increase request volume), the disclosed transportation matching system can flexibly adjust to different purposes in a quick, responsive manner (e.g., in real time or near real time). For instance, the transportation matching system can generate transportation metrics aimed at producing targeted effects such as establishment of service in new geographic areas and/or increasing requester surplus, among others as described herein.

As illustrated by the foregoing discussion, the present disclosure utilizes a variety of terms to describe features and advantages of the transportation matching system. For reference, additional detail is now provided regarding the use of these terms. For example, as used herein, the term “transportation provider” (or simply “provider”) refers to a driver or other person who operates a transportation vehicle and/or who interacts with a provider device. In particular, the term provider can include a person who drives a transportation vehicle along various routes to pick up and drop off requesters. In some embodiments, a provider can refer to an autonomous system, such as an autonomous vehicle. To illustrate, the transportation matching system matches a provider to a received request and serves instructions to the provider regarding when and where to travel in order to fulfill the matched transportation request. In response to a provider fulfilling a requested transport, the transportation matching system credits the provider based on, for example, the distance driven, the day and time, and any available incentives. The term provider can include both available providers (e.g., a provider with an unoccupied vehicle) as well as providers currently transporting a passenger in fulfillment of a transportation request.

As mentioned, in some embodiments a provider refers to an autonomous transportation vehicle—e.g., a self-driving vehicle that includes computer components and accompanying sensors for driving without manual-provider input from a human operator. In these embodiments, the transportation vehicle may include components such as location components, one or more sensors by which the autonomous vehicle navigates, and/or other components necessary to navigate without a human provider (or with minimal or reduced interactions with a human provider). Additionally, in some embodiments, a provider includes a hybrid self-driving vehicle with both self-driving functionality and some human operator interaction. This human operator interaction may work in concert with or independent of the self-driving functionality.

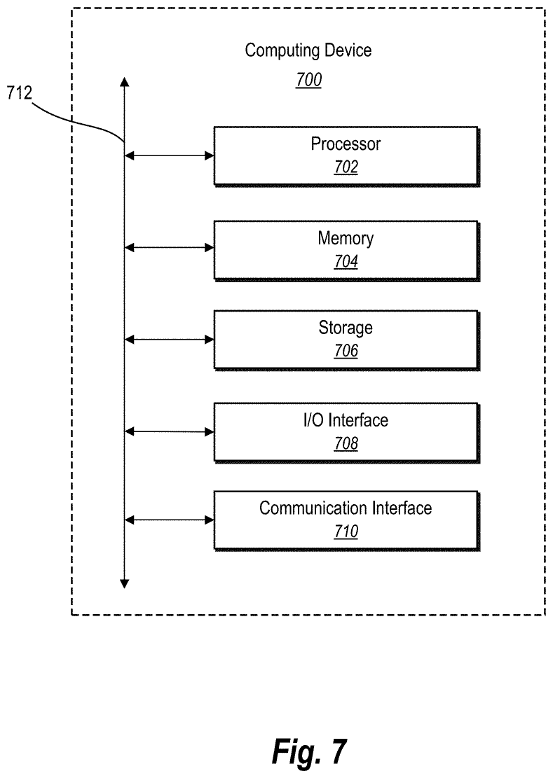

As mentioned above, providers are associated with transportation vehicles as well as provider devices. The transportation vehicle may be an airplane, automobile, bicycle, motorcycle, electric scooter, or another vehicle. As used herein, the term “provider device” refers to a computing device associated with a provider. A provider device can include a mobile device such as a laptop, smartphone, or tablet associated with the provider. However, the provider device may be any type of computing device as further explained below with reference to FIG. 7. In addition, the provider device may include provider applications that utilize web browsers, applets, or other software applications (e.g., native applications) available to the provider devices. Further, in some embodiments, a provider device is built into a transportation vehicle associated with the provider.

Although this disclosure describes a provider as performing certain functions, the provider device is often performing a corresponding function. For example, when the transportation matching system sends a transportation request to a provider—or queries location information from a provider—the transportation matching system sends the transportation request or location query to the provider device associated with the provider.

The term “requester” refers to a person (or group of people) who request pickup or other form of transportation from the transportation matching system. In particular, the term requester may include a person who requests pickup or other form of transportation but who is still waiting for pickup. A requester may also refer to a person whom a transportation vehicle has already picked up and who is currently riding within the transportation vehicle to a destination (e.g., a destination indicated by a requester).

In one or more embodiments, a requester initiates a software application of the transportation matching system and whose requester device sends a query for a price estimate and/or a query for an estimated time of arrival to the transportation matching system. Accordingly, a requester enters in a pickup location and/or destination for transportation (and optionally selects a mode or transportation type) by interacting with graphical user interfaces of a requester application on their requester device.

Relatedly, the term “requester device” refers to a computing device associated with a requester. A requester device includes a mobile device such as a laptop, smartphone, or tablet associated with a requester. However, the requester device may be any type of computing device as further explained below with reference to FIG. 7. Each of the requester devices can respectively include a requester application. In some embodiments, the requester applications comprise web browsers, applets, or other software applications (e.g., native applications) available to the requester devices. Additionally, in some instances, the transportation matching system provides data packets including instructions that, when executed by the requester devices, create or otherwise integrate requester applications within an application or webpage.

As used herein, the term “transportation request information” (or simply “request information”) refers to a collection of data sent to a transportation matching system comprising information associated with transportation for a requester. In particular, a transportation request information can refer to data sent during an ongoing application session in relation to various origins, destinations, times, and other route preferences selected by a requester. Transportation request information can include an origin (e.g., a pickup location represented by or within a particular geocoded area or geohash) specified by the requester computing device, a pickup time specified by the requester computing device, a destination (e.g., a destination geohash), a mode (e.g., single passenger transportation, air transportation, autonomous vehicle transportation, carpool transportation, luxury transportation, and/or multi-passenger multi-destination transportation) and/or other preferences associated with the requester computing device (e.g., a music preference or a provider rating preference). Once the requester chooses to request transportation based on the transportation request information (e.g., after receiving an estimated price and/or provider ETA from the transportation matching system), the transportation matching system matches the request to at least one provider (e.g., a transportation provider) who utilizes an associated transportation vehicle to fulfill the request. The transportation matching system matches the transportation request to a particular provider (i.e., provider computing device) based on various factors such as the provider's proximity to the location where the request originated as well as the destination specified in the request information, driver ratings, and so forth.

As mentioned, the transportation matching system can generate a transportation metric function for a transportation request. As used herein, the term “transportation metric function” can refer to a function that the transportation matching system implements to generate a transportation metric. For example, a transportation metric function can include a function that defines a relationship between two or more transportation metrics (e.g., price and volume of transportation requests). The term “transportation metric” can refer to a metric that the transportation matching system generates to produce target effects based on optimization parameters. For example, a transportation metric can include a transportation price (e.g., a base price, a total price, or a per-mile price). In some embodiments, a transportation metric (e.g., price) can be based on a base price, an expected or predicted transportation request volume, a provider supply, and/or a predicted provider pay budget. In addition, a transportation metric can be based on different routes as defined by different combinations of origins, destinations, times, and/or modes.

In addition, as used herein, the term “optimization parameter” refers to a parameter that the transportation matching system determines or receives to generate a transportation metric. In particular, an optimization parameter can refer to a parameter or setting of the transportation matching system that dictates how the transportation matching system utilizes transportation metric functions to generate corresponding transportation metrics. For example, an optimization parameter can include an indication to optimize for a particular target effect. As used herein, the term “target effect” can refer to a goal, target, or purpose of implementing the transportation matching system for a particular time and a particular location. For example, the transportation matching system can utilize one or more optimization parameters to optimize the generation of transportation metrics to achieve such target effects as increased and/or decreased revenue, increased and/or decreased requester surplus, increased and/or decreased transportation provider surplus, increased market share, establishment of service in new geographic areas, increased and/or decreased request volume, increased and/or decreased transportation provider availability, and/or time-based network effects (e.g., long-term growth, short-term profit, etc.).

As used herein, the term “model” refers to an algorithm, set of operations, or process for simulating and predicting a result given one or more inputs. An example of a model is a machine-learning model. As used herein, the term “machine-learning,” refers to the process of constructing and implementing algorithms that can learn from and make predictions on data. For example, a machine-learning model can utilize algorithms to learn from, and make predictions on, known data by analyzing the known data to learn to generate outputs that reflect patterns and attributes of the known data. Thus, a machine-learning model makes high-level abstractions in data by generating data-driven predictions or decisions from the known input data. In various embodiments, a machine-learning model can include but is not limited to, support vector machines, linear regression, logistic regression, Bayesian networks, clustering, K-nearest neighbors (KNN), K-means, random forest learning, dimensionality reduction algorithms, boosting algorithms, artificial neural networks, deep learning, etc.

As mentioned, the transportation matching system can utilize one or more models to generate transportation metrics. For example, the transportation matching system can utilize an online transportation optimization model. As used herein, the term “online transportation optimization model” can refer to a model that the transportation matching system utilizes in real time to process received transportation requests. In particular, an online transportation optimization model can refer to a model that the transportation matching system implements to process transportation request information (of a transportation request), analyze the transportation request information, and generate a transportation metric in response to the transportation request information.

In addition, the transportation matching system can utilize an offline transportation optimization model. As used herein, the term “offline transportation optimization model” can refer to a model that the transportation matching system utilizes to generate (e.g., pre-generate) predicted transportation requests for a given time interval in anticipation of future transportation requests. In particular, the transportation matching system can implement an offline transportation optimization model to analyze historical data from past transportation requests, for corresponding geographic areas (e.g., origin and destination locations) and times to generate predicted transportation requests for a given future time interval. In addition, the transportation matching system can utilize the offline transportation optimization model to generate transportation metric functions for the predicted transportation requests. Further, the transportation matching system can utilize the offline transportation optimization model to generate transportation metrics based on the transportation metric functions for the predicted transportation requests.

As also mentioned, the transportation matching system can utilize an elasticity model. As used herein, the term “elasticity model” can refer to a model that the transportation matching system utilizes to generate a transportation metric function corresponding to a received transportation request. In some embodiments, the transportation matching system can utilize the elasticity model to generate transportation metric functions for predicted transportation requests.

Additionally, the transportation matching system can utilize a feature generator model. As used herein, the term “feature generator model” refers to a model that the transportation matching system utilizes to generate predictions of request features. In some embodiments, a feature generate model can include a feature database that the transportation matching system utilizes to store and access request features associated with transportation requests. For example, the transportation matching system can utilize a feature generator model with (or independent of) an online transportation optimization model and/or an offline transportation optimization model to generate and store request features associated with predicted transportation requests as well as received transportation requests. As used herein, the term “request feature” refers to a parameter or feature associated with a transportation request and/or a transportation route. For example, a request feature can include a shadow price (e.g., a measure of how valuable a provider is at a given location), an incentive cost (e.g., a measure of incentives to provide to a provider), a marginal cost of transportation, and/or a profit-surplus tradeoff.

Additionally, the term “time interval,” as used herein, refers to an interval of time determined or set by the transportation matching system. A time interval may be any time interval, including, but not limited to, a one-minute interval, a one-hour interval, a one-week interval, etc. For example, a time interval may be a five-minute interval from 2:15 p.m. to 2:20 p.m. on Thursday, Jun. 14, 2018. As another example, a time interval may be a one-week interval from 5:03 p.m. on Sunday, Feb. 4, 2018 to 5:03 p.m. on Sunday, Feb. 11, 2018. In some embodiments, for example, the transportation matching system sets a time interval for which to forecast data, such as an estimated or predicted number of transportation requests.

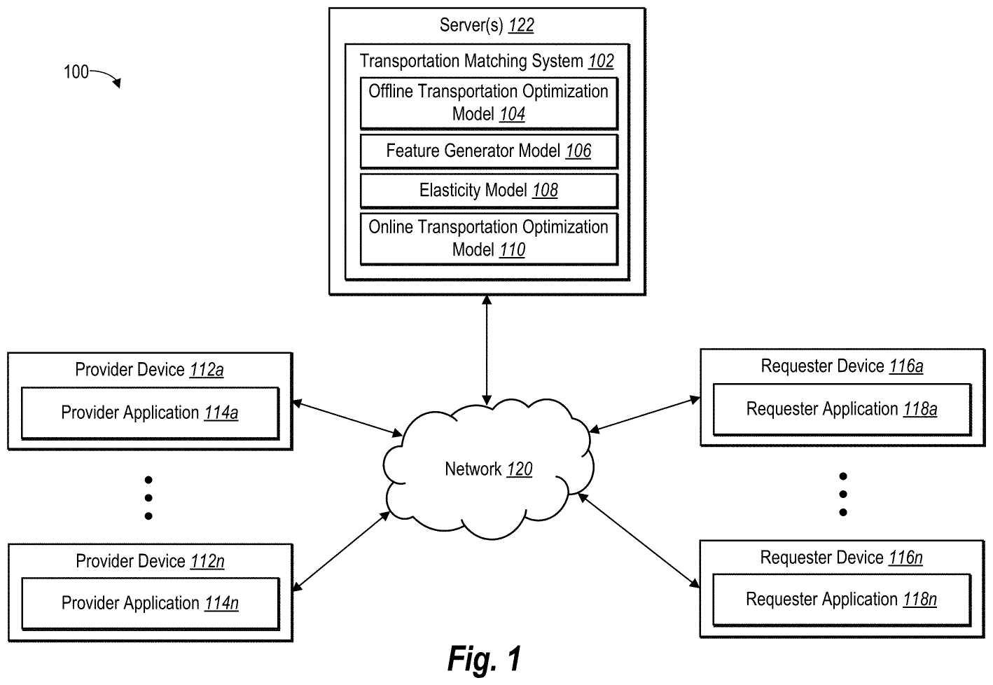

Referring now to the figures, the figures illustrate the transportation matching system with respect to managing and allocating transportation providers between areas in a region by training and/or applying various models, as well as generating transportation metrics for various transportation requests. While the following figures provide illustrations and accompanying description with respect to driver-operated cars, the figures apply to other types of transportation vehicles as well as driverless or autonomous vehicles that can freely travel between areas within a region. Further, the description with respect to FIG. 1 provides an overview of the transportation matching system. Much of the disclosure thereafter describes components and processes of the transportation matching system in further detail with reference to subsequent figures.

To illustrate, FIG. 1 includes a block diagram of an environment 100 for implementing a transportation matching system 102 in accordance with one or more embodiments. As shown in FIG. 1, the environment 100 includes the transportation matching system 102 on the server(s) 122, provider devices 112a-112n, requester devices 116a-116n, and a network 120. The server(s) 122 can include one or more computing devices to implement the transportation matching system 102. Additional description regarding the illustrated devices (122, 112a-112n, and 116a-116n) is provided with respect to FIG. 7 below.

As shown, the transportation matching system 102 utilizes the network 120 to communicate with the provider devices 112a-112n and the requester devices 116a-116n. For example, the transportation matching system 102 communicates with the provider devices 112a-112n and the requester devices 116a-116n via the network 120 to determine locations of the provider devices 112a-112n and the requester devices 116a-116n, respectively. In some embodiments, per device settings, the transportation matching system 102 may receive location coordinates from the provider devices 112a-112n and/or the requester devices 116a-116n to indicate a geocoded area (e.g., a geohash) where the provider devices 112a-112n and/or the requester devices 116a-116n are located. Indeed, the transportation matching system 102 may receive transportation requests from requester devices 116a-116n that indicate transportation request information such as an origin, a destination, and a time.

More specifically, the transportation matching system 102 connects transportation requests with transportation vehicles. By connecting requests with transportation vehicles, the transportation matching system 102 manages the distribution and allocation of providers (e.g., a provider's transportation vehicle) throughout areas in a region. For example, to facilitate connecting requests with transportation vehicles, the transportation matching system 102 communicates with the provider devices 112a-112n (through provider applications 114a-114n) and with the requester devices 116a-116n (through requester applications 118a-118n).

As mentioned above and as shown in FIG. 1, each of the provider devices 112a-112n include provider applications 114a-114n. In many embodiments, the transportation matching system 102 communicates with the provider devices 112a-112n through the provider applications 114a-114n. Additionally, the provider applications 114a-114n optionally include computer-executable instructions that, when executed by the provider devices 112a-112n, cause the provider devices 112a-112n to perform certain functions. For instance, the provider applications 114a-114n can cause the provider devices 112a-112n to communicate with the transportation matching system 102 to navigate to various places such as a target area, a requester's pickup location, a requester's destination location, as well as collect fares and bonuses for completed transportation requests.

Relatedly, as mentioned above, each of the requester devices 116a-116n includes a requester application 118a-118n, respectively. A requester may use a requester application to request transportation services, receive a price estimate for the transportation service, and access other transportation-related services. For example, a requester may interact with the requester device 116a through graphical user interfaces of the requester application 118a to enter a pickup location and a destination for transportation. The transportation matching system 102 can, in turn, generate a transportation metric (e.g., a price) to provide to the requester device 116a, an estimated time of arrival of a provider (or transportation vehicle), or access to other transportation-related services through the requester application 118a. Having received the price estimate, the requester may then select (and the requester device 116a detect) a selection of a transportation-request option to request transportation services from the transportation matching system 102.

To overcome the challenges described above, the transportation matching system 102 employs a number of models and other components. For example, as shown in FIG. 1, the transportation matching system 102 includes an offline transportation optimization model 104, a feature generator model 106, an elasticity model 108, and an online transportation optimization model 110.

Each of the models and components of the transportation matching system 102 are described in detail below. As a brief overview, however, the transportation matching system 102 can be located on a computing device (e.g., the server(s) 122). For example, in some embodiments, the computing device is a non-mobile device, such as a desktop or server, or another type of computing device. In other embodiments, the computing device is a mobile device, such as a laptop, a tablet, a mobile telephone, a smartphone, etc. Although not illustrated in FIG. 1, the transportation matching system 102 can be located in whole or in part on a requester device 116a-116n, and/or a provider device 112a-112n. Additional details regarding the computing device are discussed below as well as with respect to FIG. 7.

As shown, the transportation matching system 102 includes an offline transportation optimization model 104. In general, the offline transportation optimization model 104 generates transportation metric functions for predicted transportation requests. In particular, the offline transportation optimization model 102 analyzes previous transportation requests to generate predicted future transportation requests for a given location (e.g., geohash) over a given time interval. In addition, the offline transportation optimization model 104 generates transportation metric functions that represent or define an elasticity (e.g., a relationship) between requester supply or demand and transportation price. In some embodiments, the offline transportation optimization model 104 communicates with an elasticity model 108 to generate the transportation metric functions. Additionally, the offline transportation optimization model 104 can determine one or more optimization parameters that indicate a target effect. For example, the offline transportation optimization model 104 can receive an optimization parameter(s) from an administrator for producing a target effect. Based on the optimization parameter(s) and the transportation metric functions, the transportation matching system 102 generates transportation metrics to produce the target effect.

As also shown, the transportation matching system 102 includes a feature generator model 106. In particular, the feature generator model 106 communicates with the offline transportation optimization model 104 to receive predicted transportation requests. Based on the predicted transportation requests, the feature generator model 106 and/or the offline transportation optimization model 104 generates request features associated with the predicted transportation requests and stores the request features in a feature database. In addition, the feature generator model 106 communicates with the online transportation optimization model 110 to receive request information pertaining to a received transportation request. Based on the received transportation request information, the feature generator model 106 provides request features associated with the received transportation request. Indeed, the request features may be generated using real-time models or may use pre-computed route parameters associated with one or more offline transportation optimization models (e.g., the offline transportation optimization model 104).

In addition, the transportation matching system 102 includes an elasticity model 108. In particular, the elasticity model 108 generates transportation metric functions corresponding to predicted transportation requests and/or received transportation requests. For example, the elasticity model 108 communicates with the offline transportation optimization model 104 to generate transportation metric functions for transportation requests predicted at a given location for a given time interval. In a similar fashion, the elasticity model 108 communicates with the online transportation optimization model 110 to generate a transportation metric function for a received transportation request. Thus, the elasticity model can generate transportation metric functions that define an elasticity between requester supply and transportation price. In some embodiments, each transportation metric function specific to a particular origin, destination, and time.

The transportation matching system 102 further includes an online transportation optimization model 110. In particular, the online transportation optimization model 110 can receive transportation request information from a requester device 116a. In addition, the online transportation optimization model 110 can receive one or more optimization parameters associated with (e.g., indicating) one or more target effects. The online transportation optimization model 110 can identify transportation request information specifying an origin, a destination, a time, a mode, a transportation distance, a music preference, and/or other information. The online transportation optimization model 110 can further store the transportation request information in a database accessible by (or as part of) the feature generator model 106. Based on the transportation request information, the online transportation optimization model 110 can access a transportation metric function for the transportation request to generate a transportation metric associated for the transportation request. For example, the online transportation optimization model 110 can receive one or more optimization parameters and, utilizing a transportation metric function, can determine a transportation metric to produce the target effect (e.g., to increase revenue, increase request volume, etc.).

In one or more embodiments, each of the components of the transportation matching system 102 are in communication with one another using any suitable communication technologies. Additionally, the components of the transportation matching system 102 can be in communication with one or more other devices including one or more user client devices described above. It will be recognized that although the components of the transportation matching system 102 are shown to be separate in FIG. 1, any of the subcomponents may be combined into fewer components, such as into a single component, or divided into more components as may serve a particular implementation. Furthermore, although the components of FIG. 1 are described in connection with the transportation matching system 102, at least some of the components for performing operations in conjunction with the transportation matching system 102 described herein may be implemented on other devices within the environment 100.

The components of the transportation matching system 102 can include software, hardware, or both. For example, the components of the transportation matching system 102 can include one or more instructions stored on a computer-readable storage medium and executable by processors of one or more computing devices. When executed by the one or more processors, the computer-executable instructions of the transportation matching system 102 can cause a computing device to perform the methods described herein. Alternatively, the components of the transportation matching system 102 can comprise hardware, such as a special purpose processing device to perform a certain function or group of functions. Additionally or alternatively, the components of the transportation matching system 102 can include a combination of computer-executable instructions and hardware.

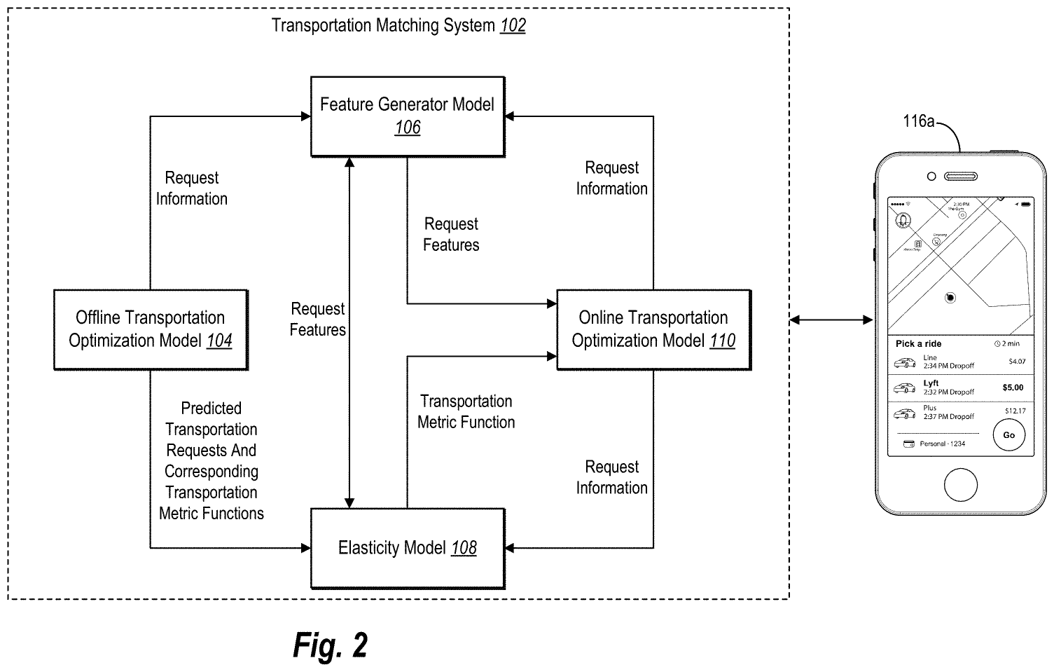

As mentioned, the transportation matching system 102 generates transportation metrics to produce target effects in relation to transportation requests. For example, FIG. 2 illustrates the transportation matching system 102 in communication with a requester device 116a to provide a transportation metric based on a received transportation request. As shown, the transportation matching system 102 includes the above-described components such as the offline transportation optimization model 104, the feature generator model 106, the elasticity model 108, and the online transportation optimization model 110. With reference to FIG. 2, additional detail is provided hereafter regarding each of the constituent components of the transportation matching system 102.

Generally, the transportation matching system 102 can receive and utilize various inputs to produce certain outputs relating to transportation requests. The transportation matching system 102 utilizes these inputs and outputs to, for a given target effect, generate transportation metric functions and/or request features that achieve a target effect. For example, the transportation matching system 102 generates trade-offs between short-run profit and a level of targeted non-profit benefits. To that end, the transportation matching system 102 can determine or receive, as input, a demand forecast, a conversion prediction, a supply cost, and/or a variable transportation cost. As output, the transportation matching system 102 can generate transportation metrics in the form of base prices, expected request volume, provider supply needed, and/or provider pay budget.

As mentioned, the transportation matching system 102 can receive or determine a demand forecast input. To illustrate, the transportation matching system 102 can determine a baseline estimate of passenger intent relative to different routes. A “route” can refer to a travel path defined at least by an origin, a destination, and a time, which are collectively referred to herein as an “ODT”. In some cases, a route can further include a mode and can be designated as an “ODTM.” Additionally, an “origin” and a “destination” can each refer to a respective geographic location as defined by a particular geohash (e.g., geohash-6 or geohash-7). An origin can indicate a pickup location of a transportation request, and a destination can indicate a drop-off location of a transportation request. Based on various routes, the transportation matching system 102 can identify demand patterns based on geographic location, seasonal demand changes, event-related demand changes (e.g., as a result of concerts, business conferences, sporting events, etc.), and/or weather.

In addition, the transportation matching system 102 can predict passenger conversion rates for a given origin, destination, time (e.g., hour of week), and/or mode. For example, the transportation matching system 102 can monitor passenger conversion rates for different ODTM price levels. To illustrate, the transportation matching system 102 monitors requester input within application sessions to determine a percentage of requesters for a given ODTM that accept a given price. Based on monitoring these rates, the transportation matching system 102 can generate a conversion function to predict passenger conversion rates on an ODTM level. In addition, the transportation matching system 102 can generate a conversion function that adapts to different geographic locations, times, seasons, weather, and/or events.

Additionally, the transportation matching system 102 can determine a supply cost relative to given OTMs (origins, times, and modes). For example, for a given origin (or request location), the transportation matching system 102 can determine a total cost (or marginal cost) of request supply given different numbers of requests. Additionally, the transportation matching system 102 can determine a measure of error (e.g., root mean square error) of a supply cost according to a number of providers available to service transportation requests.

The transportation matching system 102 can further determine variable transportation costs at different times in a given geographic location. For example, the transportation matching system 102 can analyze a particular geohash to identify transportation costs for different ODTs, OTMs, and/or ODTMs. Over a given time interval, the transportation matching system 102 can analyze changes in the transportation costs to detect trends or patterns to utilize in predicting variable transportation costs.

To improve predictions of transportation requests, the transportation matching system 102 can measure the progress of each of the above-mentioned parameters—demand forecast, conversion prediction, supply cost, and variable transportation cost. In particular, the transportation matching system 102 can determine a measure of error (e.g., root mean square error) associated with each parameter and can adjust to reduce the various errors. For example, the transportation matching system 102 can compare predictions with ground truth observations to determine a measure error. To reduce the error, the transportation matching system 102 can adjust metrics associated with one or more models to adjust respective predictions.

To determine the above-mentioned inputs and/or to generate the above-mentioned outputs, the transportation matching system 102 can implement the components illustrated in FIG. 2. The transportation matching system 102 implements the offline transportation optimization model 104 to generate predicted transportation requests. To illustrate, the transportation matching system 102 accesses historical information such as previous transportation requests to use as a basis for generating predicted transportation requests. For example, the transportation matching system 102 analyzes historical information for geographic locations (e.g., an origin and/or a destination) over a given time interval (e.g., one week). For a given origin and/or destination, the transportation matching system 102 can determine a percentage (e.g., 90%) of transportation requests over a previous time interval (e.g., a previous week) that will repeat or correspond to future transportation requests for a subsequent time interval (e.g., next week). Thus, the transportation matching system 102 can predict transportation requests for a time interval based on historical data.

The transportation matching system 102 can also determine routes associated with the predicted transportation requests. For example, the transportation matching system 102 can analyze routes (e.g., ODTs) associated with previous transportation requests and, similar to the above discussion, can generate predicted routes based on historical routes. The transportation matching system 102 forecasts routes (and/or transportation requests) by generating a geohash-6 (“GH-6”) pair (e.g., a GH-6 origin and a GH-6 destination) based on an hourly count of requester demand. For example, the transportation matching system 102 determines, for a given time interval, a number of requests per hour for a given GH-6 pair. In some embodiments, the transportation matching system 102 further considers mode as part of a route, thereby resulting in the transportation matching system 102 generating predictions in the form of a GH-6 pair with a particular mode—an ODTM.

In circumstances where GH-6 pairs are sparse, the transportation matching system 102 further implements an aggregation technique to circumvent possible prediction errors. For example, if the transportation matching system 102 determines that request demand per hour (e.g., a number of requests per hour) is below a particular threshold, then the transportation matching system 102 can implement a nearest neighbor algorithm or a k-means clustering algorithm to aggregate transportation requests for generating more accurate predictions.

Based on the predicted transportation requests, the transportation matching system 102 utilizes the offline transportation optimization model 104 to generate transportation metrics for the predicted transportation requests. Indeed, the transportation matching system 102 can generate a transportation metric for each predicted transportation request based on its ODT, ODTM, or OTM. In addition, the transportation matching system 102 can generate a transportation metric for a transportation request further based on request features from the feature generator model 106.

In some embodiments, the transportation matching system 102 generates metrics according to various constraints. For example, the transportation matching system 102 can utilize a time constraint to generate metrics periodically (e.g., once a week). In addition, or alternatively, the transportation matching system 102 can utilize a provider supply constraint. For a given time interval, the transportation matching system 102 determines total provider hours required to serve a request demand that results from a generated metric. In addition, the transportation matching system 102 can impose a constraint that the provider hours should be less than an expected available provider supply considering the historical efficiency of the provider supply.

The transportation matching system 102 can further implement a profitability constraint. For example, the transportation matching system 102 can determine that profit for a given location should satisfy a particular profit threshold. The transportation matching system 102 can further implement a mode constraint. For example, the transportation matching system 102 can determine a relationship between the demands of different modes (e.g., multi-passenger vs. single-passenger) and impose a constraint to maintain that relationship. In some embodiments, the transportation matching system 102 can impose other constraints to generating transportation metrics such as distance constraints (e.g., by requiring ODTs/ODTMs of a threshold distance to generate transportation metrics), time constraints (e.g., by adjusting metrics at particular times), or others.

To generate a transportation metric, the offline transportation optimization model 104 accesses a transportation metric function for a given transportation request (or for a given route). Indeed, the offline transportation optimization model 104 can communicate with the elasticity model 108 to access a transportation metric function. To generate such functions for access in the first place, the transportation matching system 102 utilizes the elasticity model 108. Indeed, to generate a transportation metric function for a given predicted transportation request, the elasticity model 108 receives transportation request information (e.g., an ODT) and generates a function based on the transportation request information. For example, the elasticity model 108 generates a transportation metric function that defines how transportation price for a given ODT effects requester supply (e.g., transportation request volume). The elasticity model 108 can generate transportation metric functions that reflect other metrics as well such as expected provider supply need and/or expected provider pay budget.

The offline transportation optimization model 104 utilizes the generated transportation metric functions for the predicted transportation requests to generate corresponding transportation metrics. In some embodiments, for a given transportation request, the transportation matching system 102 utilizes the offline transportation optimization model 104 to select a particular price point of a transportation metric function. In other embodiments, the transportation matching system 102 utilizes the offline transportation optimization model 104 to generate a different transportation metric such as a request volume, a provider supply, or a provider pay budget, where each different type of transportation metric corresponds to a different transportation metric function.

As mentioned, the transportation matching system 102 can further receive transportation request information. More particularly, the transportation matching system 102 receives transportation request information from a requester device (e.g., requester device 116a) in response to, for example, a requester opening a requester application (e.g., requester application 118a). Indeed, the transportation matching system 102 can communicate with the requester device 116a to receive transportation request information specifying an ODT or ODTM. Based on receiving the transportation request information, the transportation matching system 102 can utilize the online transportation optimization model 110 to determine a route associated with the transportation request. For example, the transportation matching system 102 can determine an ODT or ODTM such as a geohash-7 (“GH-7”) pair for the origin and destination, and a time indicated by an hour of the week.

In addition to receiving transportation request information, the transportation matching system 102 can further receive a transportation request associated with the received transportation request information. To elaborate, the transportation matching system 102 receives a transportation request from a requester device 116a based on detecting or receiving a user interaction with the requester application 118a. For example, in some embodiments the transportation matching system 102 receives a selection of a button or other graphical element to indicate a transportation request. Based on receiving the transportation request, the transportation matching system 102 further provides information to one or more provider devices 112a-112n and enables the provider devices 112a-112n to accept the transportation request.

Based on the ODT/ODTM of the received transportation request, the transportation matching system 102 can utilize the online transportation optimization model 110 to identify a corresponding ODT/ODTM from the predicted transportation requests. To illustrate, the online transportation optimization model 110 identifies a predicted transportation request that has an ODT/ODTM within a threshold similarity of the received transportation request. For example, the transportation matching system 102 can determine a similarity score between transportation requests by comparing origins, destinations, times, and/or modes of predicted transportation requests with those of the received transportation request. Shorter distances between origins can indicate a higher degree of similarity, as can shorter distances between destinations, shorter differences in time, and the same or similar modes of transportation.

In addition, the online transportation optimization model 110 can communicate with the elasticity model 108 to access a transportation metric function generated for the corresponding predicted transportation metric function. Indeed, as described, the elasticity model 108 generates transportation metric functions for predicted transportation metrics. Thus, by identifying a transportation metric function for a request that is similar to (or the same as) the received transportation request, the online transportation optimization model 110 can generate a transportation metric by, for example, selecting a price point from the transportation metric function.

In some embodiments, the transportation matching system 102 receives a transportation request from the requester device 116a that does not have a corresponding predicted transportation request. For instance, the transportation matching system 102 can determine that, based on the ODT/ODTM of the received request as well ODT/ODTMs of the predicted transportation requests, no predicted transportation requests are within a threshold similarity. In these or other embodiments, the transportation matching system 102 utilizes the elasticity model 108 to generate a transportation metric function for the received transportation request.

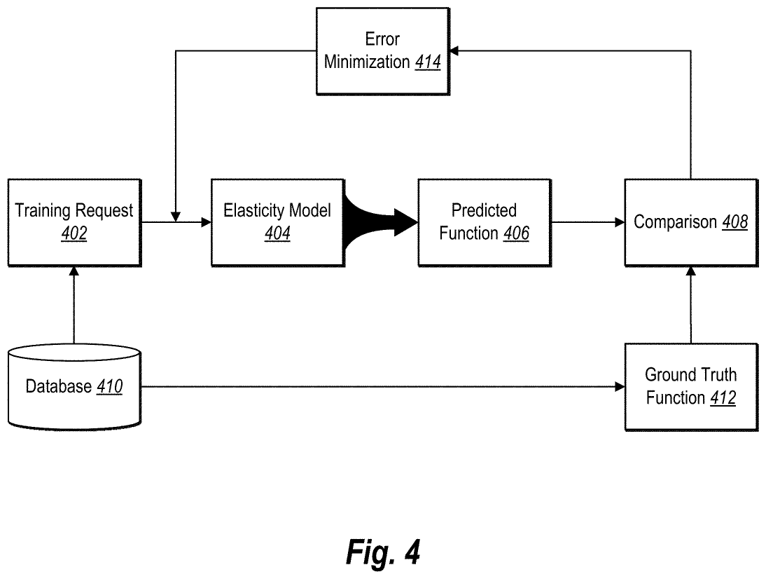

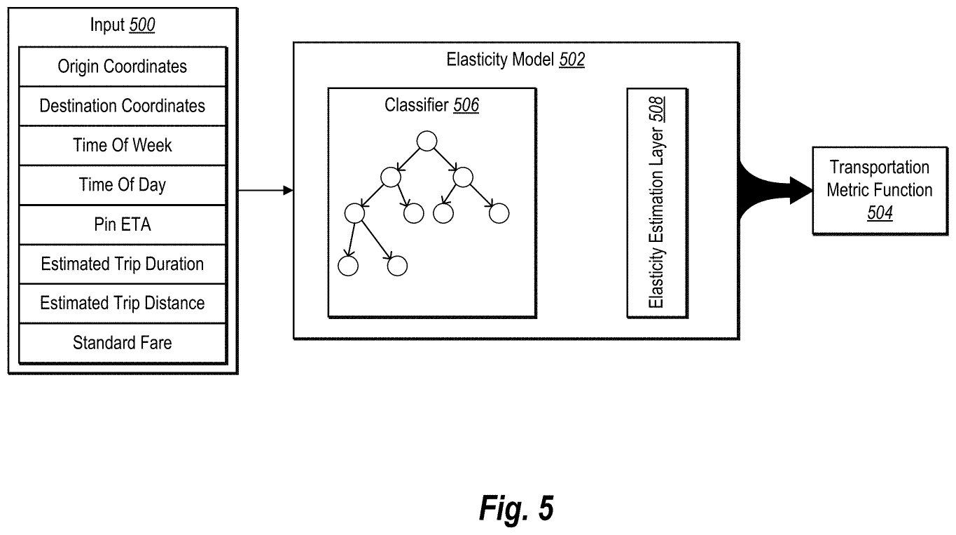

To illustrate, the transportation matching system 102 can train the elasticity model 108 to generate transportation metric functions. Indeed, the offline transportation optimization model 104 can provide training data to the elasticity model 108, the training data including predicted transportation requests and corresponding transportation metric functions. In some embodiments, the elasticity model 108 accesses information (e.g., training data) from the feature generator model 106 (e.g., from a feature database associated with the feature generator model 106) to analyze for generating or determining a transportation metric function. In the same or other embodiments, the transportation matching system 102 trains the elasticity model 108 based on actual observed data such as previous transportation requests and observed transportation metric data corresponding to the previous transportation requests. By training the elasticity model 108 to generate transportation metric functions, the transportation matching system 102 can utilize the online transportation optimization model 110 to generate transportation metrics for a received transportation request even if the received request does not correspond to (e.g., match) a predicted transportation request. Additional detail regarding training the elasticity model 108 is provided below with reference to FIGS. 4 and 5.

Additionally, the transportation matching system 102 generates metrics for the received request. To elaborate, the transportation matching system 102 utilizes the online transportation optimization model 110 to generate a transportation metric for the received request. The online transportation optimization model 110 can communicate with the elasticity model 108 to access a transportation metric function that corresponds to the received transportation request. In addition, the online transportation optimization model 110 can determine a transportation metric based on the transportation metric function by, for example, selecting a point of the function that corresponds to a target effect.

Indeed, the transportation matching system 102 can select different points of a function to generate metrics to optimize for target effects. For example, the transportation matching system 102 can optimize for per transport profitability (e.g., a measure based on passenger fare, passenger fare discounts, variable costs, driver pay, and/or driver incentives), lifetime value, or maximizing transportation requests (e.g., based on Ramsey Pricing or Robin Hooding), among other effects. As mentioned, the transportation matching system 102 can optimize transportation metrics associated with received transportation requests (e.g., via the online transportation optimization model 110).

To that end, the transportation matching system 102 determines optimization parameters that indicate target effects associated with transportation requests. In some embodiments, the transportation matching system 102 receives optimization parameters from an administrator to set a target effect for the transportation matching system 102. In other embodiments, the transportation matching system 102 determines optimization parameters based on historical information such as previous optimization parameters and/or previous performance of the transportation matching system 102. For example, the transportation matching system 102 can receive or determine an optimization parameter that indicates to optimize a transportation metric for achieving the target effect of increasing request volume. In response, the transportation matching system 102 utilizes the offline transportation optimization model 104 and/or the online transportation optimization model 110 to generate a metric that, when applied to a given ODT or OTDM, will produce the target effect of increasing request volume for that ODT/ODTM.

In addition, the transportation matching system 102 generates transportation metrics in accordance with an optimization technique. For example, the transportation matching system 102 can implement a knapsack technique (e.g., bin packing) to determine a transportation metric based on various objectives or target effects. As an example, the transportation matching system 102 can implement a knapsack algorithm to maximize conversions in a given area with a constraint on weekly per transport profitability. For example, the transportation matching system 102 can determine a constraint of a particular monetary value of per transport profitability for a given week and can implement a knapsack algorithm to generate metrics that will result in numbers of requests at different price levels to satisfy the constraint. In some embodiments, the constraint is configurable by an administrator and/or by the transportation matching system 102 to flexibly adapt the generation of transportation metrics for target effects.

In some embodiments, the transportation matching system 102 further utilizes the feature generator model 106 to predict, store, and provide transportation metrics that are determined or collected for transportation requests. In particular, the transportation matching system 102 utilizes the feature generator model 106 to predict, store, and provide request features associated with transportation requests. Indeed, based on the ODT/ODTM of a given transportation request, the transportation matching system 102 utilizes the online transportation optimization model 110 or the offline transportation optimization model 104 to generate request features associated with the ODT/ODTM and to store the request features from the feature generator model 106 (e.g., from a feature database associated with the feature generator model 106). Additionally, the online transportation optimization model 110, the offline transportation optimization model 104, and the elasticity model 108 access the request features from the feature generator model 108 to generate transportation metric functions and corresponding transportation metrics. For example, the feature generator model 106 can store and provide request features such as shadow prices, ride time (e.g., time from pickup to destination), pickup information, marginal costs (e.g., distance-based prices of transportation), conversion estimates, historical primetime levels (e.g., request volume during primetime hours), shared ride information, expected numbers of drivers for servicing particular transportation types, supply required (e.g., number of hours and/or providers required for a given request volume) incentive costs, and profit-surplus tradeoff.

As mentioned, the offline transportation optimization model 104 and the online transportation optimization model 110 communicate with the feature generator model 106 to access request features associated with predicted and received transportation requests, respectively. Based on the request features, the offline transportation optimization model 104 and the online transportation optimization model 110 generate transportation metrics by implementing the request features in determining, for example, per transport profitability. As another example, the offline transportation optimization model 104 and the online transportation optimization model 110 can utilize request features such as shadow price to optimize metrics based on provider value.

Although FIG. 2 illustrates the feature generator model 106 and the elasticity model 108 independent from and external to the offline transportation optimization model 104, in some embodiments the offline transportation optimization model 104 includes the feature generator model 106 and the elasticity model 108. Similarly, in some embodiments the online transportation optimization model 110 can include the feature generator model 106 and/or the elasticity model 108. That is to say, the offline transportation optimization model 104 and/or the online transportation optimization model 110 can perform the various functionality described herein in relation to the feature generator model 106 and/or the elasticity model 108.

Upon generating a transportation metric for the received transportation request, the transportation matching system 102 can further communicate with the requester device 116a to provide the transportation metric. In particular, the transportation matching system 102 can generate and provide a response that includes an indication of the generated transportation metric. In some embodiments, the response can include an estimated price of a transportation request during a requester's application session.

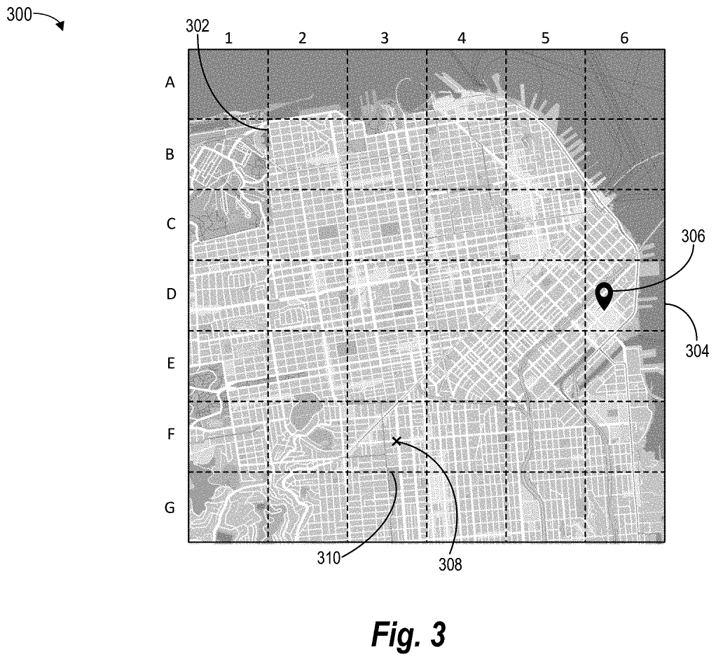

To illustrate an example of the above disclosure, FIG. 3 provides a simplified depiction of a geographic region 300 divided into hypothetical geocodes representative of geohashes (e.g., GH-6s or GH-7s). For example, the geographic location 302 is represented by the geocode B-2, and the geographic location 304 is represented by the geocode D-6. As shown in FIG. 3, the transportation matching system 102 receives a transportation request for the location indicated by the pin 306.

Based on receiving the transportation request, the transportation matching system 102 determines request information associated with the request. In particular, the transportation matching system 102 determines an ODT or an ODTM for the transportation request. As shown, the transportation matching system 102 determines the location 304 (D-6) as the location associated with the request (e.g., the pickup location or origin). In addition, the transportation matching system 102 determines the location 310 (F-3) as the location of the destination 308. Furthermore, the transportation matching system 102 determines a time (e.g., an hour of the week) associated with the transportation request by determining a pickup time for scheduling a provider to meet the requester at the origin location. Thus, the transportation matching system 102 determines an ODT associated with the transportation request.

In some embodiments, the transportation matching system 102 further determines a mode for the transportation request. In particular, the transportation matching system 102 receives an indication of a transportation mode from the requester device 116a. For example, the transportation matching system 102 receives an indication of a request for carpool transportation, single passenger transportation, luxury transportation, or some other mode of transportation. Thus, the transportation matching system 102 determines an ODTM for the transportation request.

Based on the determined ODT/ODTM of the transportation request, the transportation matching system 102 generates a transportation metric to provide to the requester device 116a. In particular, the transportation matching system 102 generates a transportation metric function based on predicted transportation requests associated with the region 300. In line with the description above, the transportation matching system 102 implements an offline transportation optimization model to generate predicted transportation requests for the region 300. In addition, the transportation matching system 102 generates transportation metric functions for the predicted transportation requests.

Thus, in some embodiments the transportation matching system 102 identifies a predicted transportation request that corresponds to the received transportation request. For instance, the transportation matching system 102 identifies a predicted transportation request that has an ODT that corresponds to (e.g., resembles or contains similar information to) the ODT of the received request. Indeed, the transportation matching system 102 determines that a predicted request has an origin that corresponds to the origin of the received request. Similarly, the transportation matching system 102 determines that the destination and time also resemble or reflect information similar to those of the received request. In some embodiments, the transportation matching system 102 need not match all three components of the ODT but may only need to match two of the three to identify a similar request (or three of the four in the case of an ODTM request). In other embodiments, as described above, the transportation matching system 102 implements a similarity threshold determination based on differences between origins, destinations, and times.

Based on identifying a predicted request that matches the received request, the transportation matching system 102 further utilizes the predicted transportation metric function of the predicted request as the metric function associated with the received request. Indeed, the transportation matching system 102 can assume that similar ODTs will have similar functions based on the factors described above. In other embodiments, however, the transportation matching system 102 generates a transportation metric function by utilizing an elasticity model, as also described above. For instance, the transportation matching system 102 utilizes the elasticity model trained to generate metric functions based on training data such as training requests and corresponding ground truth metric functions.

In some embodiments, the transportation matching system 102 generates transportation metric functions (e.g., via the elasticity model 108, the offline transportation optimization model 104, and/or the online transportation optimization model 110) to accomplish a target effect of particular optimization parameters. As an example, the transportation matching system 102 generates transportation metric functions to optimize shared requests (e.g., requests where requesters share transportation with one or more other requesters). To illustrate, the transportation matching system 102 determines and stores request features based on received transportation requests including shared and non-shared requests. In addition, the transportation matching system 102 determines request features such as a volume of shared requests in a particular area. Based on the request features, the transportation matching system 102 utilizes the request features to optimize a volume of shared requests. For instance, the transportation matching system 102 generates (e.g., via the offline transportation optimization model 104) a prediction of shared transportation request information (e.g., volume, price, origin, destination, time) for the area and further generates (e.g., via the elasticity model 108) a transportation metric function and a corresponding transportation metric to achieve a desired volume (e.g., increased or decreased) of shared requests.

In some embodiments, the transportation matching system 102 generates a transportation metric function based on destination-based pricing. To illustrate, based on received transportation requests, the transportation matching system 102 generates (e.g., via the offline transportation optimization model 104) a prediction of requests that include destinations in particular locations. For example, the transportation matching system 102 predicts a volume of requests that designate a destination in a particular geohash that generally has a low request volume. Based on this prediction, the transportation matching system 102 generates (e.g., via the elasticity model 108) a transportation metric function to achieve a target effect of increasing the incentive for providers to service requests to that particular location (e.g., by increasing the price of the transportation to that location).

In any event, the transportation matching system 102 generates a transportation metric function for the received request and utilizes the function to determine a transportation metric. For instance, the transportation matching system 102 determines a price for the transportation request and provides the price to the requester device 116a for presentation to the requester. The requester can then accept the price, whereupon the transportation matching system 102 can match a provider to service the request for the agreed-upon price.

As mentioned, the transportation matching system 102 can train an elasticity model to generate transportation metric functions. FIG. 4 illustrates an example process of training an elasticity model 404 in accordance with one or more embodiments. As shown, the transportation matching system 102 can train the elasticity model based on training data such as training requests and corresponding ground truth metric functions.

In particular, the transportation matching system 102 can access a database 410 to identify a training transportation request 402. The transportation matching system 102 can input the training request 402 into the elasticity model 404, whereupon the elasticity model 404 generates a predicted metric function 406. For instance, the transportation matching system 102 accesses the database 410 to identify a predicted or observed transportation request as the training request 402. Indeed, the elasticity model 404 can refer to a machine learning model such as a neural network. Thus, based on analyzing the training request 402, the elasticity model 404 can generate a predicted transportation metric function 406 associated with the training request 402.

In addition, the transportation matching system 102 can access the database 410 to identify a ground truth transportation metric function 412 that corresponds to the training request 402. For instance, the transportation matching system 102 identifies a predicted transportation metric function (corresponding to a predicted request) as the ground truth function 412. Thus, the transportation matching system 102 can utilize the ground truth function 412 to perform a comparison 408 between the predicted function 406 and the ground truth function 412. For example, the transportation matching system 102 can perform the comparison 408 by utilizing a loss function to determine a measure of less or error between the predicted function 406 and the ground truth function 412. Such loss functions can include mean squared error loss functions, Kullback-Leibler loss functions, and cross-entroy loss functions, among others.

Additionally, the transportation matching system 102 performs an error minimization 414 to reduce the measure of loss between the predicted function 406 and the ground truth function 412. In particular, the transportation matching system 102 reduces error by modifying parameters associated with the elasticity model 404. For instance, the transportation matching system 102 adjusts parameters such as attention weights, neural network layer parameters, or other parameters associated with the architecture of the elasticity model 404.

The transportation matching system 102 repeats the training process illustrated in FIG. 4 to improve the accuracy of the elasticity model 404. More specifically, the transportation matching system 102 identifies additional training requests and ground truth functions to use as training data. Thus, by repeatedly generating predicted functions based on the training data, comparing the generated predicted functions to ground truth functions, and adjusting parameters to reduce the resultant error, the transportation matching system 102 improves the accuracy of the elasticity model 404. Upon determining that the elasticity model 404 generates predicted functions within a threshold error, the transportation matching system 102 can implement the elasticity model 404 to generate a transportation metric function for a received transportation request (e.g., by utilizing the transportation request as input).

Although FIG. 4 illustrates training the elasticity model, in some embodiments the transportation matching system 102 can train one or more of the other above-described models as well. For example, the transportation matching system 102 can train the offline transportation optimization model 104, the online transportation optimization model 110, and/or the feature generator model 106. Indeed, the transportation matching system 102 can utilize training data to train the offline transportation optimization model 104 to predict transportation requests and corresponding transportation metric functions. Similarly, the transportation matching system 102 can train the feature generator model 106 to generate request features based on training request information and ground truth parameters.

To obtain training data to train one or more of the models described herein, the transportation matching system 102 can implement a control-exposure experiment. To elaborate, the transportation matching system 102 can continuously record conversion corresponding to various transportation metrics (e.g., at various price points) on and ODT/ODTM basis. Generally, a price for a given ODT is stable, so the transportation matching system 102 can introduce perturbations (up and down) to the transportation metric and record corresponding changes in conversion levels. In addition, the transportation matching system 102 can monitor and record various metrics at which requesters are willing to switch between transportation modes.

To expound on the control-exposure experiment, the transportation matching system 102 can implement a bucketing technique. For example, the transportation matching system 102 can determine a percentage (e.g., 10%) of geographic locations (e.g., GH-7s) that the transportation matching system 102 will expose to treatment (e.g., the perturbations or changes in transportation metric). Particularly, the transportation matching system 102 can allocate this percentage by randomly selecting geographic locations periodically (e.g., every hour) and adjusting the transportation metric for all corresponding ODTs/ODTMs. For instance, the transportation matching system 102 can randomly select 10% of the GH-7s in every GH-6 to apply this treatment. In addition, the transportation matching system 102 can apply and/or generalize the learned sensitivity from the GH-7 level on the larger GH-6 level (e.g., for predicted transportation requests). The transportation matching system 102 can utilize the remaining percentage (e.g., 90%) of geographic locations as a control group that the transportation matching system 102 will not expose to the changes in transportation metric.

For the treatment group, the transportation matching system 102 adjusts transportation metrics such as price up to plus or minus 50% of a base metric. As an example, the transportation matching system 102 can determine a base price of $10 for a particular ODT. Thus, for the treatment group, the transportation matching system 102 can adjust the price to $5 or $15. In some embodiments, the transportation matching system 102 can adjust the metric based on a lower percentage such as 20%. Thus, in the previous example, the transportation matching system 102 can adjust the price from $10 to $8 or $12. Additionally, the transportation matching system 102 can utilize the base price of $10 for the control group (i.e., the remaining percentage of requesters not in the treatment group).

The transportation matching system 102 can observe changes based on the adjustments to the metrics. For instance, the transportation matching system 102 can observe an increase in requester volume in response to lowering the price. Conversely, the transportation matching system 102 can record a decrease in requester volume in response to increasing the price. Thus, based on the observed effects from the treatment group, the transportation matching system 102 can obtain training data. In particular, the transportation matching system 102 can generate ground truth transportation metric functions that represent observed changes in requester demand resultant from the altered transportation requests. The transportation matching system 102 can utilize the training data to train one or more models as described above.

As mentioned, the transportation matching system 102 can utilize an elasticity model (e.g., the elasticity model 108 or 404) in the form of a machine learning model to generate transportation metric functions based on various request information from current real-time transportation requests and/or from predicted transportation requests. FIG. 5 illustrates an example architecture of the elasticity model 502 (e.g., elasticity model 108 and/or the elasticity model 404).

As illustrated in FIG. 5, the elasticity model 502 generates a transportation metric function 504 based on various input 500. Indeed, the transportation matching system 102 provides inputs for a given transportation request (actual or predicted) such as origin coordinates (e.g., latitude and longitude), destination coordinates, time of week, time of day, standard pin ETA, estimated trip duration, estimated trip distance, and standard fare exposed to the passenger (which can be split into three additive components: standard fare with zero primetime value component, a primetime component of a standard fare, and an exogenous change in standard fare). In some embodiments, the input 500 can further include information pertaining to various coupons and/or holidays. Because coupons and holidays ultimately affect request behavior from potential requestors, the input 500 can include indicators of requests during holidays, requests before holidays, requests after holidays, requests during long weekends, and/or requests associated with (e.g., motivated by or received with) coupons.

In addition to the input 500, the transportation matching system 102 utilizes the elasticity model 502 to generate the transportation metric function 504 based on monotonic constraints. For example, the transportation matching system 102 implements the elasticity model 502 that prevents picking up on spurious relationships between features and that further prevents overfitting in the wrong direction. In some embodiments, the transportation matching system 102 utilizes an XGBOOST boosted tree model to account for such monotonic constraints as part of generating or determining a transportation metric 504. For example, based on negative monotonic constraints, as exogenous variation of a transportation metric (e.g., price) goes up, then conversion is guaranteed to be non-increasing.

As shown in FIG. 5, the elasticity model 502 includes various components such as the classifier 506 and the elasticity estimation layer 508. As illustrate, the transportation matching system 102 can implement a classifier 506 in the form of a gradient boosted trees classifier with a binary cross entropy (log loss) loss function. Indeed, the classifier 506 can include one or more gradient boosted trees associated with one or more of the inputs 500. To generate a predicted classification, the transportation matching system 102 utilizes an ensemble of decision trees that process information (e.g., the input 500) in a stage-wise fashion (e.g., the result from one stage or level of the decision tree affects the subsequent analysis via different branches of the tree). In addition, the transportation matching system 102 modifies parameters (e.g., weights) of the classifier 506 to reduce an error or measure of loss associated with the decision trees based a binary cross entropy loss function.

The gradient boosted trees classifier 506 provides estimates of based conversion when the exogenous change in the transportation metric is zero. In some embodiments, however, the transportation matching system 102 implements a different type of classifier, such as a neural network classifier, to predict classifications of the input 500. Based on the monotonic constraints mentioned above, the transportation matching system 102 further utilizes an elasticity estimation layer 508 as part of the elasticity model 502 to generate the transportation metric function 504.

Based on the generated estimates of base conversion (e.g., receiving a transportation request for a particular value of a transportation metric that is, for example, constant or unchanging) from the classifier 506, the elasticity estimation layer 508 determines a probability of session conversion for a given mode as a function of a percentage change in the transportation metric (after some transformations to convert percentage change in the transportation metric to features of the elasticity model 502). In the case of a session, the elasticity estimation layer 508 generates a probability of conversion, which ranges from 0 to 1. Additionally, based on the monotonic constraints, the probability of conversion is guaranteed to be monotonically non-increasing with respect to changes in the transportation metric.

Given the classifications from the classifier 506, and by varying exogenous change in standard fare and holding all other input 500 constant, the transportation matching system 102 utilizes the elasticity estimation layer 508 to generate tuples of (p_{classic}, p_{classic}^{new}),which are the basis of the transportation metric function 504. Indeed, the transportation matching system 102 utilizes the elasticity model 502 to plot the various tuples to determine a function that, for a given set of input 500, defines the relationship between the probability of conversion and the transportation metric. More specifically, the transportation matching system 102 can fit elasticity of demand as given by:

$${p}_{classic} = {p}_{clasic}^{0} * {( \frac{{P}_{c l a s s i c}^{n e w}}{{P}_{classic}^{0}} )}^{{∈}_{classic}}$$

where p_{classic} is the probability of conversion for a classic mode of transportation, p_{classic}⁰ is the probability of conversion for a classic mode at a baseline transportation metric for both a line mode and a classic mode, P_{classic}^{new} is a new transportation metric for classic mode (P_{classic}^{new}=P_{classic}⁰+e_{classic}), P_{classic}⁰ is the baseline transportation metric for classic mode, and ∈_{classic} is the elasticity of the transportation metric for conversion of a classic mode request with respect to its own transportation metric.

Given the elasticity of demand equation above as well as the information for the tuples, the transportation matching system 102 can utilize the elasticity estimation layer 508 to further apply the log transformation to fit a linear model to the data. For example, the transportation matching system 102 generates the transportation metric function 504, as a linear representation, as given by:

$$log {p}_{classic} = log {p}_{c l a s s i c}^{0} + {∈}_{c l a s s i {c}^{*}} log ( \frac{{P}_{c l a s s i c}^{n e w}}{{P}_{c l a s s i c}^{0}} ) .$$

Indeed, the transportation matching system 102 generates linear representations for the transportation metric function 504 for both the online transportation optimization model 110 and the offline transportation optimization model 104 to make optimization more tractable. For instance, fitting a constant elasticity demand function ensures that the elasticity does not change as the transportation metric changes, and thus the transportation matching system 102 generates transportation metric functions (of, for example, conversion with respect to price) that are not quadratic. In other embodiments, however, the transportation matching system 102 fits the elasticities using some other curve (other than linear).

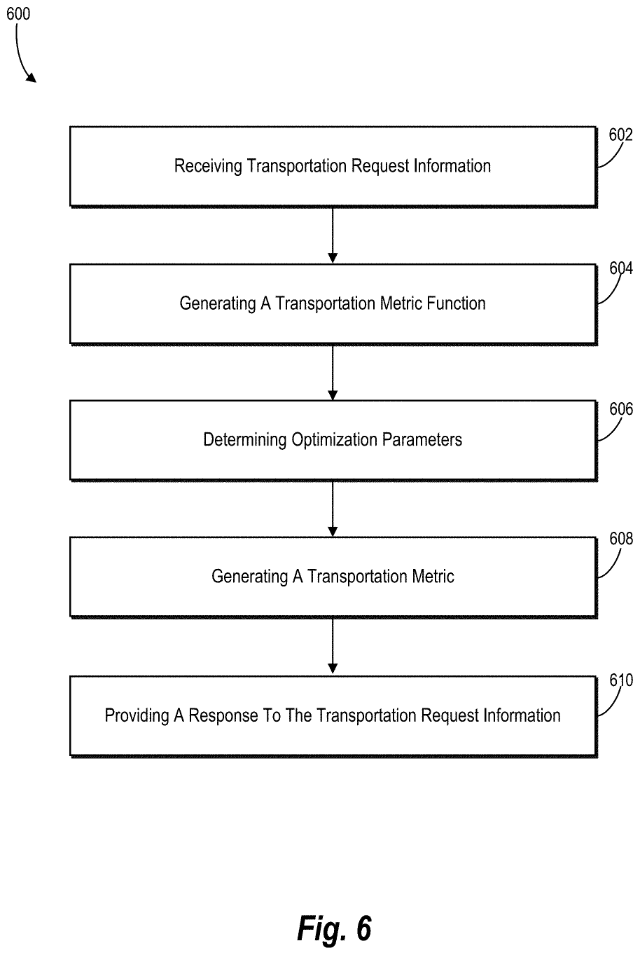

FIGS. 1-5, the corresponding text, and the examples provide a number of different systems, methods, and non-transitory computer readable media for generating and providing transportation metrics. In addition to the foregoing, embodiments can also be described in terms of flowcharts comprising acts for accomplishing a particular result. For example, FIG. 6 illustrates a flowchart of an example sequence of acts in accordance with one or more embodiments.

While FIG. 6 illustrates acts according to some embodiments, alternative embodiments may omit, add to, reorder, and/or modify any of the acts shown in FIG. 6. The acts of FIG. 6 can be performed as part of a method. Alternatively, a non-transitory computer readable medium can comprise instructions, that when executed by one or more processors, cause a computing device to perform the acts of FIG. 6. In still further embodiments, a system can perform the acts of FIG. 6. Additionally, the acts described herein may be repeated or performed in parallel with one another or in parallel with different instances of the same or other similar acts.

FIG. 6 illustrates an example series of acts 600 of generating and providing a transportation metric. As shown, the series of acts 600 includes an act 602 of receiving transportation request information. In particular, the act 602 can involve receiving, by a transportation matching system, transportation request information from a requester device, the transportation request information including an origin, a destination, and a time. Transportation request information can further include or specify one or more of a mode of transportation, a transportation distance, or a music preference.

As illustrated, the series of acts 600 also includes an act 604 of determining a transportation metric function. In particular, the act 604 can involve generating a transportation metric function specific to the origin, the destination, and the time. The act 604 can further involve determining that no previously-generated transportation metric function corresponds to the received transportation request information and utilizing the offline transportation optimization model of the transportation matching system to generate a new transportation metric function specific to the origin, the destination, and the time of the received transportation request information. The act 604 can also (or alternatively) involve identifying, by the offline transportation optimization model of the transportation matching system and from a plurality of previously-generated transportation metric functions, a transportation metric function that corresponds to the received transportation request information.

The act 604 can further involve utilizing an elasticity model to generate, based on the origin, the destination, and the time of the transportation request information, a prediction of receiving a transportation request corresponding to the transportation request information. In addition, the elasticity model can include a classifier configured to generate, based on a plurality of input features, predictions of receiving transportation requests for a particular transportation metric and an elasticity estimation layer configured to determine, based on the predictions from the classifier, probabilities of receiving transportation requests based on changes in the transportation metric.

In addition, the series of acts 600 includes an act 606 of determining optimization parameters. In particular, the act 606 can involve determining one or more optimization parameters associated with the transportation request information, the one or more optimization parameters comprising a target effect associated with the transportation request information.

The series of acts 600 further includes an act 608 of generating a transportation metric. In particular, the act 608 can involve generating, by the transportation matching system utilizing the transportation metric function, a transportation metric for the transportation request based on the one or more optimization parameters to produce the target effect. For example, the act 608 can involve utilizing an elasticity model to generate a transportation metric that produces the target effect based on the transportation metric function.

Furthermore, the series of acts 600 includes an act 610 of providing a response to the transportation request information. In particular, the act 610 can involve providing, by the transportation matching system to the requester device, a response to the transportation request comprising the generated transportation metric.

Although not illustrated in FIG. 6, the series of acts 600 can also include acts of predicting, by an offline transportation optimization model of the transportation matching system, one or more transportation requests for a given time interval and generating, by the offline transportation optimization model, transportation metric functions corresponding to the predicted transportation requests. In addition, the series of acts 600 can include an act of determining, by the offline transportation optimization model of the transportation matching system, one or more predicted request features for the one or more predicted transportation requests. The series of acts 600 can also include an act of determining, by a feature generator model of the transportation matching system and based on the one or more predicted request features, one or more request features for the transportation request information. Generating the transportation metric can be performed by an online transportation optimization model and can be further based on the request features for the transportation request.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system, including by one or more servers. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, virtual reality devices, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 7 illustrates, in block diagram form, an exemplary computing device 700 that may be configured to perform one or more of the processes described above. One will appreciate that the transportation matching system 102 can comprise implementations of the computing device 700, including, but not limited to, the provider devices 112a-112n, the requester devices 116a-116n, and/or the server(s) 122. As shown by FIG. 7, the computing device can comprise a processor 702, memory 704, a storage device 706, an I/O interface 708, and a communication interface 710. In certain embodiments, the computing device 700 can include fewer or more components than those shown in FIG. 7. Components of computing device 700 shown in FIG. 7 will now be described in additional detail.

In particular embodiments, processor(s) 702 includes hardware for executing instructions, such as those making up a computer program. As an example, and not by way of limitation, to execute instructions, processor(s) 702 may retrieve (or fetch) the instructions from an internal register, an internal cache, memory 704, or a storage device 706 and decode and execute them.

The computing device 700 includes memory 704, which is coupled to the processor(s) 702. The memory 704 may be used for storing data, metadata, and programs for execution by the processor(s). The memory 704 may include one or more of volatile and non-volatile memories, such as Random Access Memory (“RAM”), Read Only Memory (“ROM”), a solid-state disk (“SSD”), Flash, Phase Change Memory (“PCM”), or other types of data storage. The memory 704 may be internal or distributed memory.

The computing device 700 includes a storage device 706 includes storage for storing data or instructions. As an example, and not by way of limitation, storage device 706 can comprise a non-transitory storage medium described above. The storage device 706 may include a hard disk drive (“HDD”), flash memory, a Universal Serial Bus (“USB”) drive or a combination of these or other storage devices.

The computing device 700 also includes one or more input or output interface 708 (or “I/O interface 708”), which are provided to allow a user (e.g., requester or provider) to provide input to (such as user strokes), receive output from, and otherwise transfer data to and from the computing device 700. These I/O interface 708 may include a mouse, keypad or a keyboard, a touch screen, camera, optical scanner, network interface, modem, other known I/O devices or a combination of such I/O interface 708. The touch screen may be activated with a stylus or a finger.

The I/O interface 708 may include one or more devices for presenting output to a user, including, but not limited to, a graphics engine, a display (e.g., a display screen), one or more output providers (e.g., display providers), one or more audio speakers, and one or more audio providers. In certain embodiments, interface 708 is configured to provide graphical data to a display for presentation to a user. The graphical data may be representative of one or more graphical user interfaces and/or any other graphical content as may serve a particular implementation.

The computing device 700 can further include a communication interface 710. The communication interface 710 can include hardware, software, or both. The communication interface 710 can provide one or more interfaces for communication (such as, for example, packet-based communication) between the computing device and one or more other computing devices 700 or one or more networks. As an example, and not by way of limitation, communication interface 710 may include a network interface controller (“NIC”) or network adapter for communicating with an Ethernet or other wire-based network or a wireless NIC (“WNIC”) or wireless adapter for communicating with a wireless network, such as a WI-FI. The computing device 700 can further include a bus 712. The bus 712 can comprise hardware, software, or both that connects components of computing device 700 to each other.

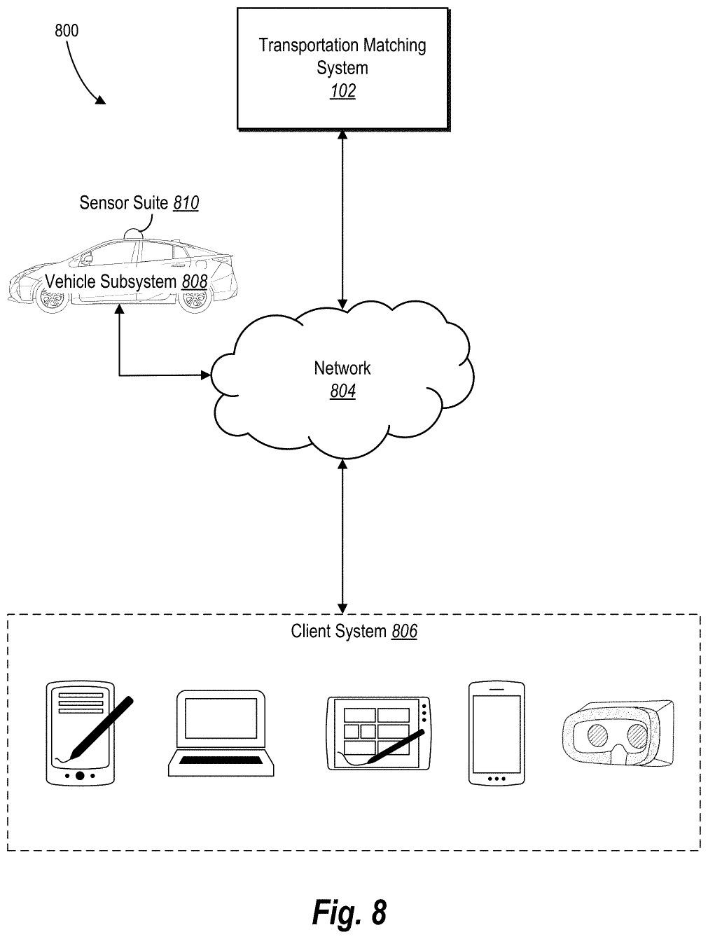

FIG. 8 illustrates an example network environment 800 of a transportation matching system. The network environment 800 includes a client device 806, a transportation matching system 102, and a vehicle subsystem 808 connected to each other by a network 804. Although FIG. 8 illustrates a particular arrangement of the client device 806, transportation matching system 102, vehicle subsystem 808, and network 804, this disclosure contemplates any suitable arrangement of client device 806, transportation matching system 102, vehicle subsystem 808, and network 804. As an example, and not by way of limitation, two or more of client device 806, transportation matching system 102, and vehicle subsystem 808 communicate directly, bypassing network 804. As another example, two or more of client device 806, transportation matching system 102, and vehicle subsystem 808 may be physically or logically co-located with each other in whole or in part. Moreover, although FIG. 8 illustrates a particular number of client devices 806, transportation matching systems 102, vehicle subsystems 808, and networks 804, this disclosure contemplates any suitable number of client devices 806, transportation matching systems 102, vehicle subsystems 808, and networks 804. As an example, and not by way of limitation, network environment 800 may include multiple client device 806, transportation matching systems 102, vehicle subsystems 808, and networks 804.

This disclosure contemplates any suitable network 804. As an example, and not by way of limitation, one or more portions of network 804 may include an ad hoc network, an intranet, an extranet, a virtual private network (“VPN”), a local area network (“LAN”), a wireless LAN (“WLAN”), a wide area network (“WAN”), a wireless WAN (“WWAN”), a metropolitan area network (“MAN”), a portion of the Internet, a portion of the Public Switched Telephone Network (“PSTN”), a cellular telephone network, or a combination of two or more of these. Network 804 may include one or more networks 804.

Links may connect client device 806, transportation matching system 102, and vehicle subsystem 808 to network 804 or to each other. This disclosure contemplates any suitable links. In particular embodiments, one or more links include one or more wireline (such as for example Digital Subscriber Line (“DSL”) or Data Over Cable Service Interface Specification (“DOCSIS”), wireless (such as for example Wi-Fi or Worldwide Interoperability for Microwave Access (“WiMAX”), or optical (such as for example Synchronous Optical Network (“SONET”) or Synchronous Digital Hierarchy (“SDH”) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout network environment 800. One or more first links may differ in one or more respects from one or more second links.

In particular embodiments, client device 806 may be an electronic device including hardware, software, or embedded logic components or a combination of two or more such components and capable of carrying out the appropriate functionalities implemented or supported by client device 806. As an example, and not by way of limitation, a client device 806 may include any of the computing devices discussed above in relation to FIG. 7. A client device 806 may enable a network user at client device 806 to access network 804. A client device 806 may enable its user to communicate with other users at other client devices 806.

In particular embodiments, client device 806 may include a requester application or a web browser, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at client device 806 may enter a Uniform Resource Locator (“URL”) or other address directing the web browser to a particular server (such as server), and the web browser may generate a Hyper Text Transfer Protocol (“HTTP”) request and communicate the HTTP request to server. The server may accept the HTTP request and communicate to client device 806 one or more Hyper Text Markup Language (“HTML”) files responsive to the HTTP request. Client device 806 may render a webpage based on the HTML files from the server for presentation to the user. This disclosure contemplates any suitable webpage files. As an example, and not by way of limitation, webpages may render from HTML files, Extensible Hyper Text Markup Language (“XHTML”) files, or Extensible Markup Language (“XML”) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, transportation matching system 102 may be a network-addressable computing system that can host a transportation matching network. Transportation matching system 102 may generate, store, receive, and send data, such as, for example, user-profile data, concept-profile data, text data, transportation request data, GPS location data, provider data, requester data, vehicle data, or other suitable data related to the transportation matching network. This may include authenticating the identity of providers and/or vehicles who are authorized to provide transportation services through the transportation matching system 102. In addition, the dynamic transportation matching system may manage identities of service requesters such as users/requesters. In particular, the dynamic transportation matching system may maintain requester data such as driving/riding histories, personal data, or other user data in addition to navigation and/or traffic management services or other location services (e.g., GPS services).

In particular embodiments, the transportation matching system 102 may manage transportation matching services to connect a user/requester with a vehicle and/or provider. By managing the transportation matching services, the transportation matching system 102 can manage the distribution and allocation of resources from the vehicle systems 108a and 108n and user resources such as GPS location and availability indicators, as described herein.

Transportation matching system 102 may be accessed by the other components of network environment 800 either directly or via network 804. In particular embodiments, transportation matching system 102 may include one or more servers. Each server may be a unitary server or a distributed server spanning multiple computers or multiple datacenters. Servers may be of various types, such as, for example and without limitation, web server, news server, mail server, message server, advertising server, file server, application server, exchange server, database server, proxy server, another server suitable for performing functions or processes described herein, or any combination thereof. In particular embodiments, each server may include hardware, software, or embedded logic components or a combination of two or more such components for carrying out the appropriate functionalities implemented or supported by server. In particular embodiments, transportation matching system 102 may include one or more data stores. Data stores may be used to store various types of information. In particular embodiments, the information stored in data stores may be organized according to specific data structures. In particular embodiments, each data store may be a relational, columnar, correlation, or other suitable database. Although this disclosure describes or illustrates particular types of databases, this disclosure contemplates any suitable types of databases. Particular embodiments may provide interfaces that enable a client device 806, or a transportation matching system 102 to manage, retrieve, modify, add, or delete, the information stored in data store.

In particular embodiments, transportation matching system 102 may provide users with the ability to take actions on various types of items or objects, supported by transportation matching system 102. As an example, and not by way of limitation, the items and objects may include transportation matching networks to which users of transportation matching system 102 may belong, vehicles that users may request, location designators, computer-based applications that a user may use, transactions that allow users to buy or sell items via the service, interactions with advertisements that a user may perform, or other suitable items or objects. A user may interact with anything that is capable of being represented in transportation matching system 102 or by an external system of a third-party system, which is separate from transportation matching system 102 and coupled to transportation matching system 102 via a network 804.

In particular embodiments, transportation matching system 102 may be capable of linking a variety of entities. As an example, and not by way of limitation, transportation matching system 102 may enable users to interact with each other or other entities, or to allow users to interact with these entities through an application programming interfaces (“API”) or other communication channels.

In particular embodiments, transportation matching system 102 may include a variety of servers, sub-systems, programs, modules, logs, and data stores. In particular embodiments, transportation matching system 102 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. Transportation matching system 102 may also include suitable components such as network interfaces, security mechanisms, load balancers, failover servers, management-and-network-operations consoles, other suitable components, or any suitable combination thereof. In particular embodiments, transportation matching system 102 may include one or more user-profile stores for storing user profiles. A user profile may include, for example, biographic information, demographic information, behavioral information, social information, or other types of descriptive information, such as work experience, educational history, hobbies or preferences, interests, affinities, or location.

The web server may include a mail server or other messaging functionality for receiving and routing messages between transportation matching system 102 and one or more client devices 806. An action logger may be used to receive communications from a web server about a user's actions on or off transportation matching system 102. In conjunction with the action log, a third-party-content-object log may be maintained of user exposures to third-party-content objects. A notification controller may provide information regarding content objects to a client device 806. Information may be pushed to a client device 806 as notifications, or information may be pulled from client device 806 responsive to a request received from client device 806. Authorization servers may be used to enforce one or more privacy settings of the users of transportation matching system 102. A privacy setting of a user determines how particular information associated with a user can be shared. The authorization server may allow users to opt in to or opt out of having their actions logged by transportation matching system 102 or shared with other systems, such as, for example, by setting appropriate privacy settings. Third-party-content-object stores may be used to store content objects received from third parties. Location stores may be used for storing location information received from client devices 806 associated with users.

In addition, the vehicle subsystem 808 can include a human-operated vehicle or an autonomous vehicle. A provider of a human-operated vehicle can perform maneuvers to pick up, transport, and drop off one or more requesters according to the embodiments described herein. In certain embodiments, the vehicle subsystem 808 can include an autonomous vehicle—i.e., a vehicle that does not require a human operator. In these embodiments, the vehicle subsystem 808 can perform maneuvers, communicate, and otherwise function without the aid of a human provider, in accordance with available technology.

In particular embodiments, the vehicle subsystem 808 may include one or more sensors incorporated therein or associated thereto. For example, sensor(s) 810 can be mounted on the top of the vehicle subsystem 808 or else can be located within the interior of the vehicle subsystem 808. In certain embodiments, the sensor(s) 810 can be located in multiple areas at once—i.e., split up throughout the vehicle subsystem 808 so that different components of the sensor(s) 810 can be placed in different locations in accordance with optimal operation of the sensor(s) 810. In these embodiments, the sensor(s) 810 can include a LIDAR sensor and an inertial measurement unit (“IMU”) including one or more accelerometers, one or more gyroscopes, and one or more magnetometers. The sensor(s) 810 can additionally or alternatively include a wireless IMU (“WIMU”), one or more cameras, one or more microphones, or other sensors or data input devices capable of receiving and/or recording information relating to navigating a route to pick up, transport, and/or drop off a requester.

In particular embodiments, the vehicle subsystem 808 may include a communication device capable of communicating with the client device 806 and/or the transportation matching system 102. For example, the vehicle subsystem 808 can include an on-board computing device communicatively linked to the network 804 to transmit and receive data such as GPS location information, sensor-related information, requester location information, or other relevant information.

In the foregoing specification, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A method for managing transportation services comprising:
receiving, by a transportation matching system, transportation request information from a requester device, the transportation request information comprising an origin, a destination, and a time;
determining a transportation metric function specific to the origin, the destination, and the time;
determining one or more optimization parameters associated with the transportation request information, the one or more optimization parameters corresponding to a target effect associated with the transportation request information;
generating, by the transportation matching system utilizing the transportation metric function, a transportation metric based on the transportation request information and the one or more optimization parameters; and
providing, by the transportation matching system to the requester device, a response to the transportation request information comprising the generated transportation metric.

2. The method of claim 1, wherein generating the transportation metric for the transportation request comprises utilizing an elasticity model to generate a transportation metric that produces the target effect.

3. The method of claim 1, wherein determining the transportation metric function comprises utilizing an elasticity model to generate, based on the origin, the destination, and the time of the transportation request information, a prediction of receiving a transportation request corresponding to the transportation request information.

4. The method of claim 3, wherein the elasticity model comprises:
a classifier configured to generate, based on a plurality of input features, predictions of receiving transportation requests for a particular transportation metric; and
an elasticity estimation layer configured to determine, based on the predictions from the classifier, probabilities of receiving transportation requests based on changes in the transportation metric.

5. The method of claim 1, wherein:
the target effect associated with the transportation request information comprises increasing a volume of shared transportation requests; and
determining the transportation metric function comprises determining a transportation metric that will increase the volume of shared transportation requests.

6. The method of claim 1, wherein:
the target effect associated with the transportation request information comprises increasing an incentive for a provider to service a transportation request that indicates a particular destination; and
determining the transportation metric function comprises determining a transportation metric that will increase the incentive for the provider to service the transportation request that indicates the particular destination.

7. The method of claim 1, wherein the transportation request information further comprises a mode of transportation, and wherein determining the transportation metric function comprises generating a transportation metric function specific to the origin, the destination, the time, and a mode of transportation.

8. A non-transitory computer readable medium comprising instructions that, when executed by at least one processor, cause a computer device to:
receive, by a transportation matching system, transportation request information from a requester device, the transportation request specifying an origin, a destination, and a time;
determine a transportation metric function specific to the origin, the destination, and the time;
determine one or more optimization parameters associated with the transportation request information, the one or more optimization parameters corresponding to a target effect associated with the transportation request information;
generate, by the transportation matching system utilizing the transportation metric function, a transportation metric based on the transportation metric and the one or more optimization parameters; and
provide, by the transportation matching system to the requester device, a response to the transportation request information comprising the generated transportation metric.

9. The non-transitory computer readable medium of claim 8, wherein the instructions cause the computer device to generate the transportation metric for the transportation request by utilizing an elasticity model to generate a transportation metric that produces the target effect.

10. The non-transitory computer readable medium of claim 8, wherein the instructions cause the computer device to determine the transportation metric function by utilizing an elasticity model to generate, based on the origin, the destination, and the time of the transportation request information, a prediction of receiving a transportation request corresponding to the transportation request information.

11. The non-transitory computer readable medium of claim 10, wherein the elasticity model comprises:
a classifier configured to generate, based on a plurality of input features, predictions of receiving transportation requests for a particular transportation metric; and
an elasticity estimation layer configured to determine, based on the predictions from the classifier, probabilities of receiving transportation requests based on changes in the transportation metric.

12. The non-transitory computer readable medium of claim 8, wherein:
the target effect associated with the transportation request information comprises increasing a volume of shared transportation requests; and
the instructions cause the computer device to determine the transportation metric function by determining a transportation metric that will increase the volume of shared transportation requests.

13. The non-transitory computer readable medium of claim 8, wherein:
the target effect associated with the transportation request information comprises increasing an incentive for a provider to service a transportation request that indicates a particular destination; and
the instructions cause the computer device to determine the transportation metric function by determining a transportation metric that will increase the incentive for the provider to service the transportation request that indicates the particular destination.

14. The non-transitory computer readable medium of claim 8, wherein the transportation request information further comprises a mode of transportation, and wherein the instructions cause the computer device to determine the transportation metric function by generating a transportation metric function specific to the origin, the destination, the time, and a mode of transportation.

15. A system for managing transportation services comprising:
at least one processor; and
a non-transitory computer readable medium comprising instructions that, when executed by the at least one processor, cause the system to:
receive transportation request information from a requester device, the transportation request information specifying an origin, a destination, and a time;
determine a transportation metric function specific to the origin, the destination, and the time;
determine one or more optimization parameters associated with the transportation request information, the one or more optimization parameters corresponding to a target effect associated with the transportation request information;
generate, utilizing the transportation metric function, a transportation metric based on the transportation request information and the one or more optimization parameters; and
provide, to the requester device, a response to the transportation request information comprising the generated transportation metric.

16. The system of claim 15, wherein the instructions cause the system to generate the transportation metric for the transportation request by utilizing an elasticity model to generate a transportation metric that produces the target effect.

17. The system of claim 15, wherein the instructions cause the system to determine the transportation metric function by utilizing an elasticity model to generate, based on the origin, the destination, and the time of the transportation request information, a prediction of receiving a transportation request corresponding to the transportation request information.

18. The system of claim 17, wherein the elasticity model comprises:
a classifier configured to generate, based on a plurality of input features, predictions of receiving transportation requests for a particular transportation metric; and
an elasticity estimation layer configured to determine, based on the predictions from the classifier, probabilities of receiving transportation requests based on changes in the transportation metric.

19. The system of claim 15, wherein:
the target effect associated with the transportation request information comprises increasing a volume of shared transportation requests; and
the instructions cause the system to determine the transportation metric function by determining a transportation metric that will increase the volume of shared transportation requests.

20. The system of claim 15, wherein:
the target effect associated with the transportation request information comprises increasing an incentive for a provider to service a transportation request that indicates a particular destination; and
the instructions cause the system to determine the transportation metric function by determining a transportation metric that will increase the incentive for the provider to service the transportation request that indicates the particular destination.
